(19) United States
(12) Patent Application Publication
(10) Pub. No.: US 2024/0199946 A1
(43) Pub. Date: Jun. 20, 2024

(54) Multifunctional Slickwater Fracturing Fluid

(71) Applicants: CNPC USA Corporation, Houston, TX (US); Beijing Huamei, Inc., Beijing (CN); China National Petroleum Corporation, Beijing (CN)

(72) Inventors: Genyao Lin, The Woodlands, TX (US); Jiangshui Huang, Sugar Land, TX (US); Fuchen Liu, Panjin (CN); Jianshen Li, Houston, TX (US); Lijun Lin, Katy, TX (US)

(73) Assignees: CNPC USA Corporation, Houston, TX (US); Beijing Huamei, Inc., Beijing (CN); China National Petroleum Corporation, Beijing (CN)

(21) Appl. No.: 18/205,236

(22) Filed: Jun. 2, 2023

Related U.S. Application Data
(63) Continuation-in-part of application No. 18/074,149, filed on Dec. 2, 2022.

(51) Int. Cl. C09K 8/68; C09K 8/584; C09K 8/588; C09K 8/60; C09K 8/80; E21B 43/16; E21B 43/267

(52) U.S. Cl. CPC C09K 8/68; C09K 8/584; C09K 8/588; C09K 8/604; C09K 8/80; E21B 43/16; E21B 43/267; C09K 2208/26; C09K 2208/28

(57) ABSTRACT

A water-soluble polymer system for suspending proppant in a fracturing fluid is disclosed herein. The polymer system can be made with acrylamide, acrylic acid, a surfactant monomer, urea, a glycol ether, sodium hydroxide, and water and when mixed in a fracturing fluid with a proppant can form three-dimensional structures by hydrophobic association. The structures can also reduce frictional energy losses in the fracturing fluid system and can increase oil recovery after fracturing occurs.

### FIELD OF THE INVENTION

This disclosure relates generally to fracturing fluid formulations and more specifically to fracturing fluids with high proppant transport and suspension properties.

### DESCRIPTION OF THE PRIOR ART

Hydrocarbons such as oil and gas may be produced from wells that are drilled into hydrocarbon reservoirs. For reservoirs that are of low permeability or with formation damage, the flow of the hydrocarbon into the production wells may be undesirably low. In these cases, the wells are often stimulated by hydraulic fracturing operations. For hydraulic fracturing treatment, a pad, which is a viscous fluid free of proppants, is first pumped at a rate and pressure high enough to break down the formation and create fractures. A fracturing fluid (carrying fluid) is then pumped to transport proppants such as sand and ceramic particles into the fractures. The proppants are used to keep the fractures open for the hydrocarbons to flow into the wellbore for recovery.

Proppant carrying capacity is one of the most important properties of the fracturing fluid. A fracturing fluid with high proppant transport capabilities may transport more proppant into the fractures. This can also allow the proppants to be carried further away from the wellbore to increase production. A major limitation with traditional slickwater fracturing fluid is reduced proppant transport capability.

Traditionally, high viscosity friction reducers (HVFRs) have been used to increase the proppant carrying capabilities of a fracturing fluid. This is due to the potential of reduced costs and improved retained conductivity. However, the use of HVFRs can result in the undesirable tradeoff of reduced fracturing length and fewer secondary fractures when compared to the use of linear guar at similar cost-based concentrations. Additionally, proppant transport capacity may still be limited with these techniques because the HVFR based fracturing fluid can only suspend proppant for seconds to minutes depending on the proppant size and density.

Other solutions to this limitation have been to include a swellable crosslinked polyacrylamide into the fracturing fluid. This can require relatively high concentrations of micro-gel fragments to provide sufficient proppant suspension.

Additional important properties of the fracturing fluid include both the frictional properties and oil displacement properties of the fracturing fluid. Traditional fracturing fluids use friction reducing additives, such as the HVFRs previously described, to reduce the amount of friction within the fracturing fluid system. Reducing the friction can help to reduce the amount of energy needed to pump the fracturing fluid into the downhole well. However, the use of the HVFRs comes with the drawbacks discussed as relating to proppant suspension above.

Further, fracturing fluids can have an effect on the oil recovery rates after the fractures have been formed. The fracturing fluid can displace the oil within the well forcing it into the wellbore. In traditional fracturing fluids, additional additives are required to achieve both the hydraulic fracturing and improved oil recovery. This introduces additional complexities in the fracturing system to properly balance all of the various additives to ensure sufficient proppant suspension, reduced system friction, and improved oil recovery.

Associative polymer systems have been used for proppant suspension. These system use traditional micellar polymerization methods with commonly used key sodium lauryl sulfate as an anionic surfactant to solubilize the insoluble hydrophobic monomer within its micelles in aqueous media. The insoluble hydrophobic monomer can be incorporated into the polymer backbone as blocks. However, only a water soluble surfactant like monomer or surfmer can be used. Due to the presence of a critical micelle concentration (CMC) of the surfactant monomer, the polymer contains some surfactant monomers that are individually incorporated into the polymer backbone and other surfactant monomers which initially form micelles and can be added to the polymer backbone as blocks. This can result in a hybrid and differing polymer structure. Therefore, there is a need in the art for fracturing fluids with high proppant transport capabilities, reduced system friction, and improved oil recovery without limiting the fracturing properties of the fracturing fluid.

### SUMMARY

A first embodiment of the present invention provides for a method of reducing friction in a fracturing fluid. The method can include mixing water and a hydrated polymer together to form a fracturing fluid. The hydrated polymer can be comprised of at least one surfactant monomer, at least one hydrophilic monomer, and at least one glycol ether. A proppant can further be added to the fracturing fluid which can be pumped at reduced frictional energy losses into a wellbore for fracturing operations.

In some embodiments, the surfactant monomer can include poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, poly(ethylene glycol) erucyl (meth)acrylate, poly(ethylene glycol) erucyl (meth)acrylamide, and combinations thereof.

In other embodiments the hydrophilic monomer can include acrylate salts, acrylate, acrylamide, 2-acrylamido-2-methylpropane sulfonic acid salts, 2-acrylamido-2-methylpropane sulfonic acid, and combinations thereof. The glycol ether can include tripropylene glycol methyl ether, triethylene glycol methyl ether, diethylene glycol n-butyl ether, diethylene glycol monobutyl ether, dipropylene glycol n-butyl ether, propylene glycol phenyl ether, ethylene glycol hexyl ether, diethylene glycol hexyl ether, ethylene glycol phenyl ether, diethylene glycol ethyl ether, tripropylene glycol methyl ether, and combinations thereof.

In alternate embodiments, the surfactant monomer can have one of the following structures where m is between 1 and 30 and n is between 1 and 50:

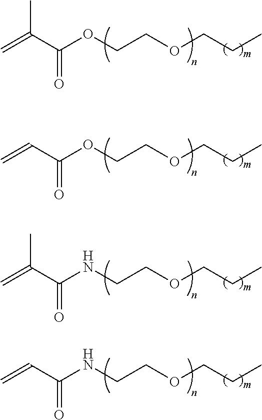

The hydrated polymer can reduce the friction of the fracturing fluid by about 75% within a minute of adding the hydrated polymer. Friction reduction of greater than about 65% can be maintained for at least 10 minutes after the polymer is added. The hydrated polymer can be added at concentrations of about 0.025 wt % or 2.08 ppt and can be mixed for at least 30 seconds. A polymer powder can also be prehydrated before being added to the water resulting in the hydrated polymer.

A second embodiment of the present technology provides for a method of improving oil recovery in a fracturing fluid. The method can include mixing water and a hydrated polymer together. The hydrated polymer can be comprised of at least one surfactant monomer, at least one hydrophilic monomer, and at least one glycol ether. A proppant can further be added to the fracturing fluid which can be pumped into a wellbore for fracturing operations. After the fracturing operation is complete, the fracturing fluid can increase oil recovered from the fractured wellbore.

In some embodiments, the surfactant monomer can include poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, poly(ethylene glycol) erucyl (meth)acrylate, poly(ethylene glycol) erucyl (meth)acrylamide, and combinations thereof.

In other embodiments the hydrophilic monomer can include acrylate salts, acrylate, acrylamide, 2-acrylamido-2-methylpropane sulfonic acid salts, 2-acrylamido-2-methylpropane sulfonic acid, and combinations thereof. The glycol ether can include tripropylene glycol methyl ether, triethylene glycol methyl ether, diethylene glycol n-butyl ether, diethylene glycol monobutyl ether, dipropylene glycol n-butyl ether, propylene glycol phenyl ether, ethylene glycol hexyl ether, diethylene glycol hexyl ether, ethylene glycol phenyl ether, diethylene glycol ethyl ether, tripropylene glycol methyl ether, and combinations thereof.

In alternate embodiments, the surfactant monomer can have one of the following structures where m is between 1 and 30 and n is between 1 and 50:

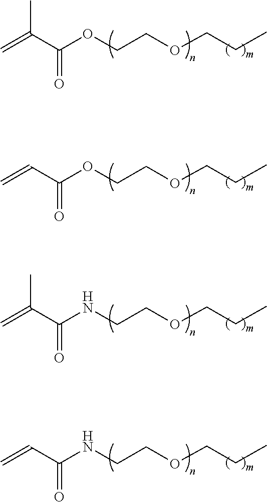

The fracturing fluid can increase both the rate and total amount of oil recovered over a period of about 10 days. The hydrated polymer can be added at concentrations between about 0.4-0.7 wt % of the fracturing fluid. The fracturing fluid can further include about 0.5 ppt of ammonium persulfate which can break the fracturing fluid to increase oil recovery.

### BRIEF DESCRIPTION OF DRAWINGS

The present technology will be better understood on reading the following detailed description of non-limiting embodiments thereof, and on examining the accompanying drawings, in which:

FIG. 1 is a method of manufacturing a polymer according to an embodiment of the present technology.

FIG. 2 is a method of using a polymer to increase proppant suspension in a fracturing fluid according to an embodiment of the present technology.

FIGS. 3A-3F are exemplary embodiments comparing proppant suspension in a fracturing fluid with the present technology and traditional methods over various periods of time.

FIG. 4 is an exemplary friction reduction embodiment with the fracturing fluid of the present technology.

FIG. 5 depicts exemplary oil recovery rates using the fracturing fluid of the present technology.

### DETAILED DESCRIPTION

The foregoing aspects, features, and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment,” “an embodiment,” “certain embodiments,” or “other embodiments” of the present invention are not intended to be interpreted as excluding the existence of additional embodiments that also incorporate the recited features. Furthermore, reference to terms such as “above,” “below,” “upper,” “lower,” “side,” “front,” “back,” or other terms regarding orientation are made with reference to the illustrated embodiments and are not intended to be limiting or exclude other orientations.

The present technology provides for a fracturing fluid based on a water-soluble polymer system with a degradable surfactant monomer. The disclosed associative polymer system can form three-dimensional network in water with sufficient hydration kinetics to greatly enhance its proppant transport capability. As compared to HVFR systems which require high viscosity to carry proppants, the disclosed fracturing fluid can have a low viscosity and suspend proppants for extended periods of time. The system can form three-dimensional structures facilitated by hydrophobic association. This can enhance proppant transport capabilities and oil recovery properties of a fracturing fluid. This can also require less water usage resulting in lower environmental impact. The fracturing fluid can be capable of suspending proppant for up to days as compared with traditional methods at comparable concentrations. The fracturing fluid can also be capable of reduced friction when compared with traditional methods using the same polymer system. The fracturing fluid can further be capable of enhanced oil recovery as compared to traditional systems.

In an aspect, the present disclosure provides a composition including at least one surfactant monomer or surfmer having a structure of:

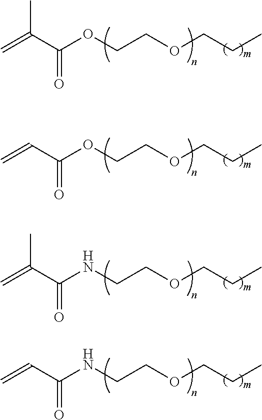

In the above exemplary surfmers, n can be any number ranging from 1 to 50 and m can be any number from 1 to 30. Other exemplary surfmers can include poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, and combinations thereof. In some embodiments, the composition includes the surfactant monomer in an amount from about 0.5 wt % to 5 wt % based on the total weight of the composition.

The composition can further include at least one hydrophilic monomer selected from acrylate salts, acrylate, acrylamide, 2-acrylamido-2-methylpropane sulfonic acid salts, 2-acrylamido-2-methylpropane sulfonic acid, and combinations thereof. The hydrophilic monomer can be present in an amount from about 10 wt % to 25 wt % of the total weight of the composition.

The composition can further include at least one glycol ether. The glycol ether can comprise one or more of tripropylene glycol methyl ether, triethylene glycol methyl ether, diethylene glycol n-butyl ether, diethylene glycol monobutyl ether, dipropylene glycol n-butyl ether, propylene glycol phenyl ether, ethylene glycol hexyl ether, diethylene glycol hexyl ether, ethylene glycol phenyl ether, diethylene glycol ethyl ether, and combinations thereof. In some embodiments, the glycol ether is tripropylene glycol methyl ether. In some embodiments, the composition can include about 1 wt % to 10 wt % of glycol ether based on the total weight of the composition.

In some embodiments, the composition can further include urea with concentrations in the range of 1 wt % to 10 wt % of the polymer composition.

In some embodiments, the composition can further include an acrylic acid with concentrations in the range of 1 wt % to 15 wt %.

In some embodiments, the composition can further include sodium hydroxide with concentrations of 3 wt % to 10 wt %.

In some embodiments, the composition can further include Na EDTA with concentrations in the range of up to about 0.05 wt %.

In some embodiments, the composition can further include water with concentrations of 40 wt % to 60 wt %.

In some embodiments, the composition can further include PCA Dimethicone with concentrations of up to about 0.05 wt %.

In some embodiments, the composition can further include a persulfate. The persulfate can be a sodium persulfate, a potassium persulfate, an ammonium persulfate, and combinations thereof. The persulfate can be included at concentrations from about 0.01 wt % to 0.5 wt % of the composition.

In some embodiments, the composition can further include sodium metabisulfite. In other embodiments, this can be a hydroxymethanesulfinic acid monosodium salt. In embodiments, these can comprise from 0.01 wt % to 0.5 wt % of the composition.

In some embodiments, the composition can further include V-50 with concentrations of 0.1 wt % to 0.5 wt %.

This polymer-based fluid can form a three-dimensional network with sufficient hydration kinetics to greatly increase proppant transport capacity.

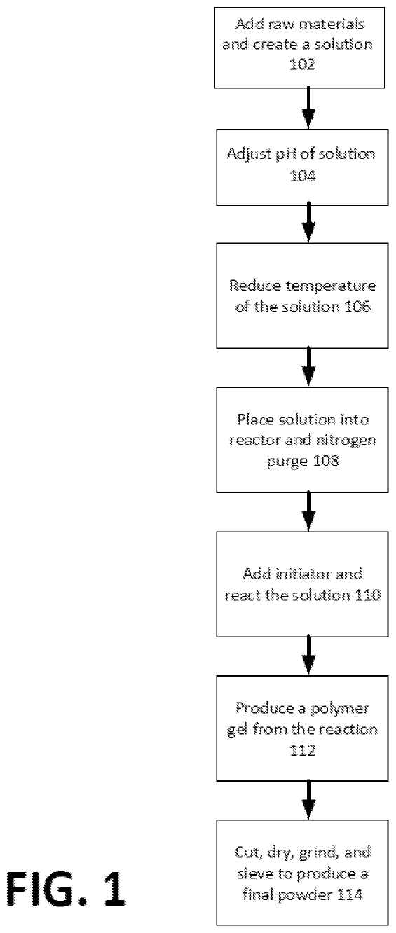

FIG. 1 depicts a method of manufacturing a polymer for increased proppant capacity in a fracturing fluid according to an embodiment of the present technology. In step 102, initial raw materials can be mixed together in solution until the solids are dissolved. The present disclosure will further be described by the exemplary raw materials and weight percentages as listed in Table 1. However, it is to be understood that alternative raw materials and weight percentages may be used in alternative embodiments of the disclosure.

TABLE 1

| | Weight Percent of | |
|---|---|---|
| Raw Material | Raw Materials | |
| Acrylamide | 17 | wt % |
| Acrylic Acid | 7.5 | wt % |
| 50% Poly(ethylene glycol) behenyl ether methacrylate | 1 | wt % |
| (MW 1500) | | |
| 50% Sodium hydroxide | 7.75 | wt % |
| Na₄EDTA | 0.01 | wt % |
| Urea | 5 | wt % |
| Tripropylene glycol methyl ether | 3 | wt % |
| Water | 58.37 | wt % |
| PCA Dimethicone | 0.01 | wt % |
| 2% Sodium persulfate | 0.05 | wt % |
| 4% Sodium metabisulfite | 0.06 | wt % |
| 10% V-50 | 0.25 | wt % |

In step 104, the pH of the solution can be adjusted to about 4.0 to 8.5, preferably to about 5 to 6.5. This can be done with sodium hydroxide. During this time, the temperature can be controlled under 30 degrees Celsius. The mixture can be further cooled to about 10 to 25 degrees Celsius in step 106. In step 108, the mixture can be placed into a reactor. The reactor can be nitrogen purged for about 15-60 minutes. In step 110, the initiators can be added to the mixture to start the reaction. In the present embodiment, the one or more initiators can include sodium persulfate, sodium metabisulfite, and V-50. The reaction can be allowed to proceed without cooling. When complete, a polymer gel can be produced in step 112. The gel can be cut, dried, grinded, and sieved in step 114 to produce a final dry powder.

The polymer gel can be added to a fracturing fluid in one of two methods. First, the polymer gel can be added directly to the fracturing fluid as a dry powder. Alternatively, the powdered polymer gel can be hydrated in water before addition to the fracturing fluid. Hydrating the polymer gel can improve the frictional properties of the fracturing fluid within the first minute of addition in comparison to the direct addition of the powder.

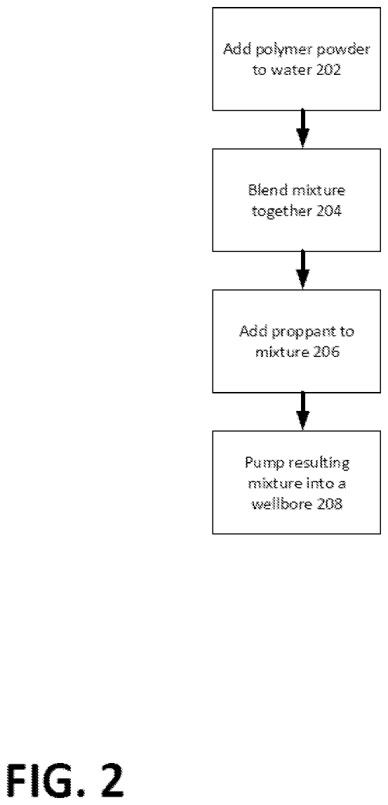

FIG. 2 provides for a method of using the polymer to increase proppant suspension in a fluid. In an embodiment, polymer powder is added to 0.5K TDS water at a 0.004 weight ratio of the polymer powder to fracturing fluid in step 202. The polymer powder weight ratio to fracturing fluid can range from 0.002 to 0.01 in alternate embodiments. The fracturing fluid and polymer powder can then be mixed in step 204. The mixing can occur with a blender at 2000 rpm for about 4 minutes. In step 206, proppant can be added to the mixture. The proppant can be added to the mixture at about a 1:4 weight ratio of proppant to fluid. The ratio of the proppant to fluid can be 1:10 to 1:2. The proppant can be a 20/40 mesh or other appropriate sizes such as 40/70, 70/140 etc.

The resulting mixture can then be pumped into a wellbore for fracturing operations in step 208. The use of the polymer can allow for the suspension of greater amounts of proppant during the fracturing operations. This can result in greater fracturing lengths and more secondary fractures than traditional fracturing fluids used in similar concentrations. In the present exemplary embodiment, the viscosity of the fluid measured at a shear rate of 511 S⁻¹ can be of greater than about 20 cp, of greater than about 30 cp, of greater than about 40 cp, of greater than about 50 cp, of greater than about 60 cp, of greater than about 70 cp, of greater than about 80 cp, of greater than about 90 cp. In general, the fracturing fluid can have a viscosity of less than 100 cp at a shear rate of 511 S⁻¹.

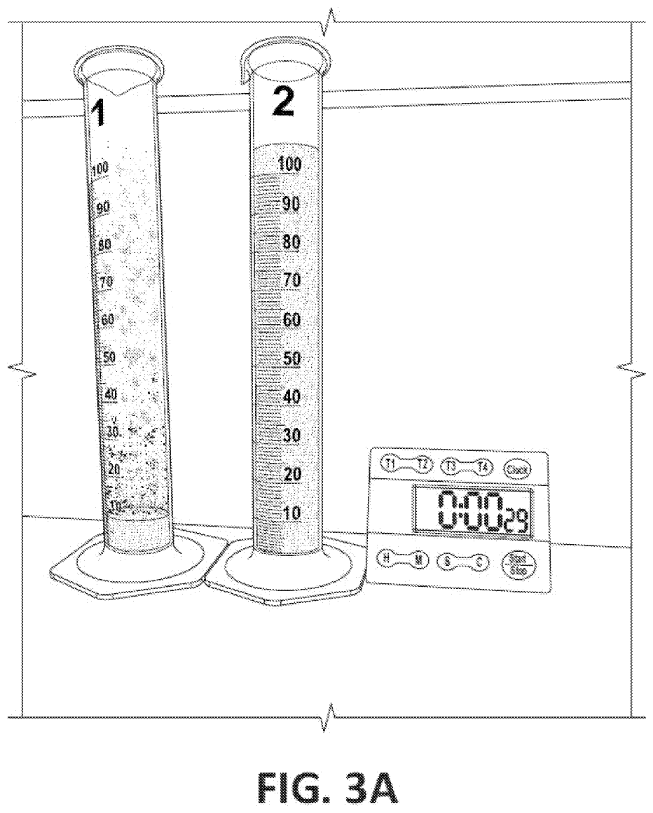

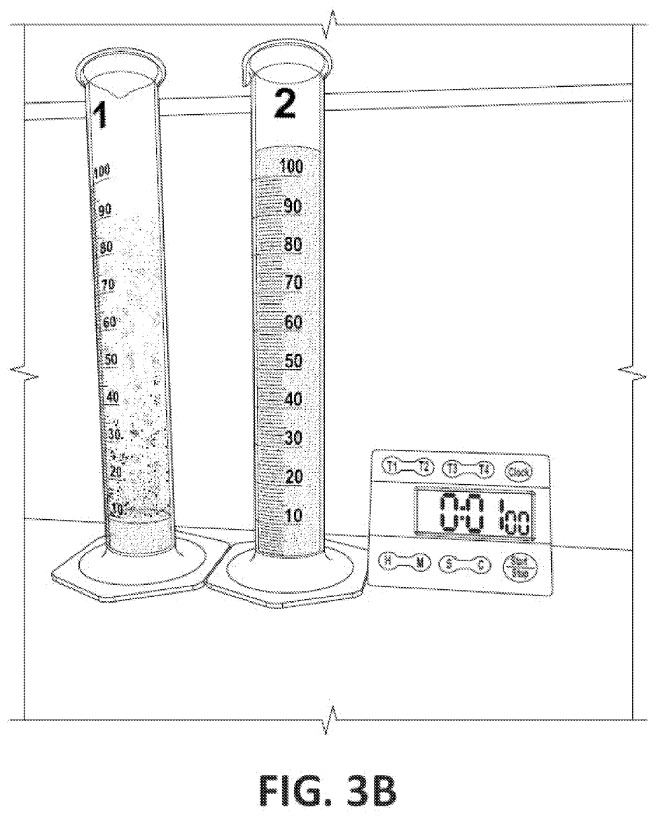

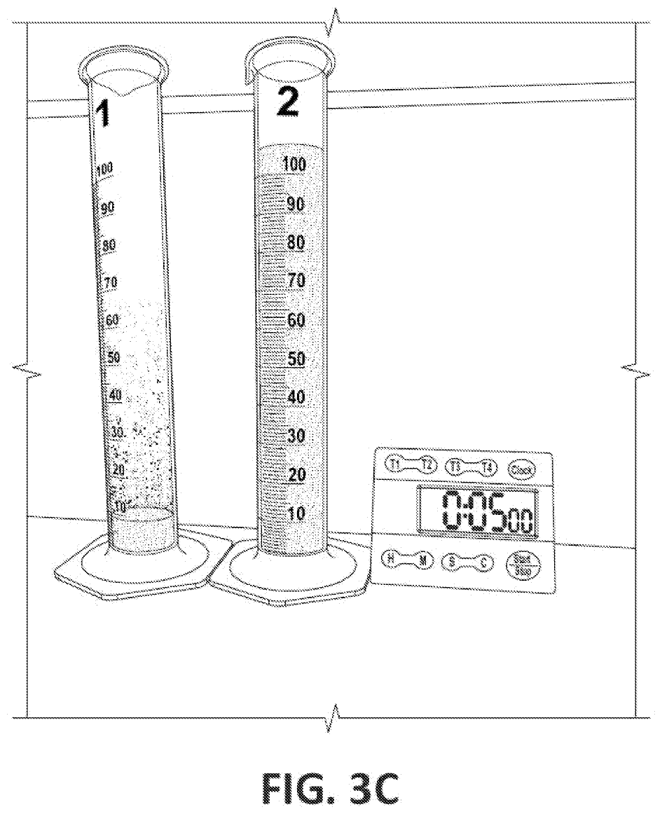

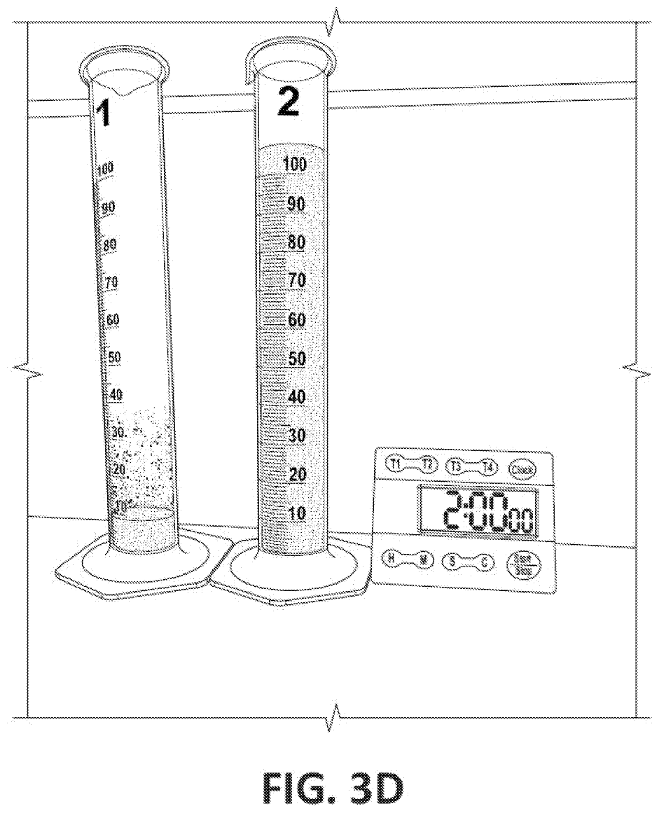

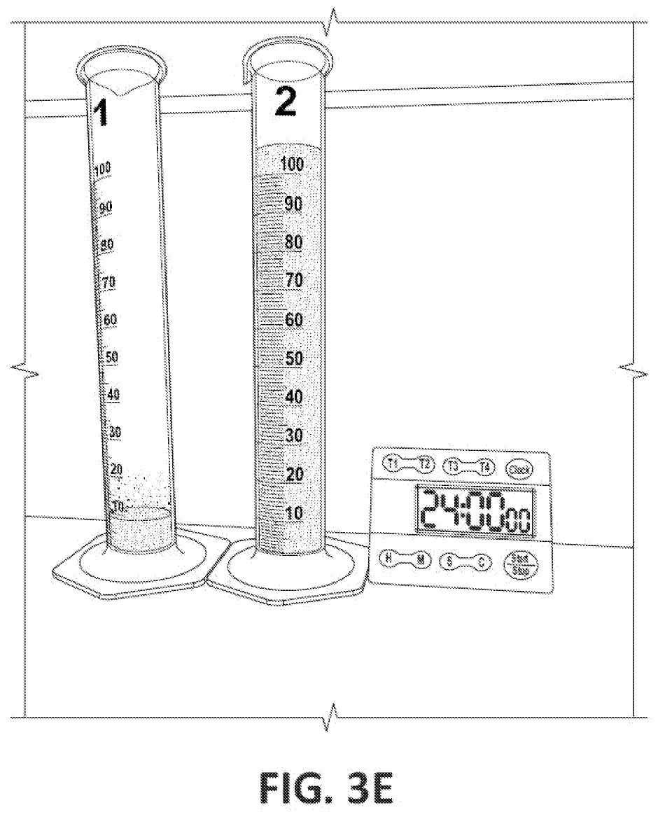

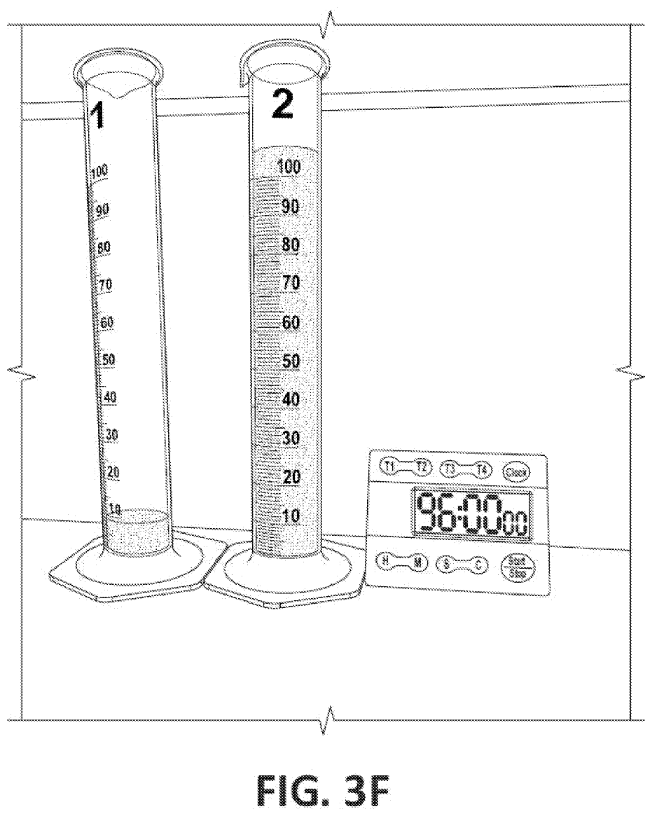

FIGS. 3A-F depict proppant settling comparisons over different time intervals. The column shown on the left uses a traditional powder friction reducer and the column on the right uses the polymer powder of the present technology. Intervals shown are 30 seconds in FIG. 3A, 1 minute in FIG. 3B, 5 minutes in FIG. 3C, 2 hours in FIG. 3D, 24 hours in FIG. 3E, and 96 hours in FIG. 3F. The figures show how the polymer settles quickly in the traditional friction reducer while remaining suspended for multiple days with the polymer of the present technology.

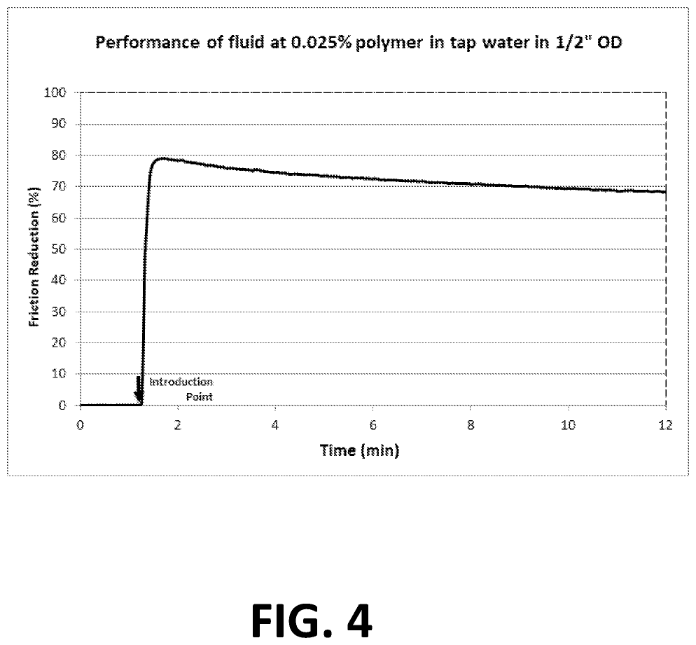

FIG. 4 depicts a demonstration of the friction reducing capabilities of the disclosed polymer system. The polymer was preheated in tap water to hydrate the polymer with an overhead mixer and a frictional baseline was established in a Chandler flowloop. The flowloop test was conducted at 6 gallons per minute (gpm) through a ½ inch diameter tubing. Once the baseline was established, the hydrated polymer was introduced to the flowloop through a hopper and mixed for 30 seconds with a hand mixer at the introduction point identified in FIG. 4. The resulting liquid consisted of 0.025% polymer in the tap water or approximately a 2.08 ppt loading of the polymer in the water.

The resulting system resulted in a peak performance of over 75% friction reduction compared to the water without the polymer addition. A reduction of 70% was maintained for approximately 8 minutes, and a reduction of over 65% was maintained for the entire duration of the test.

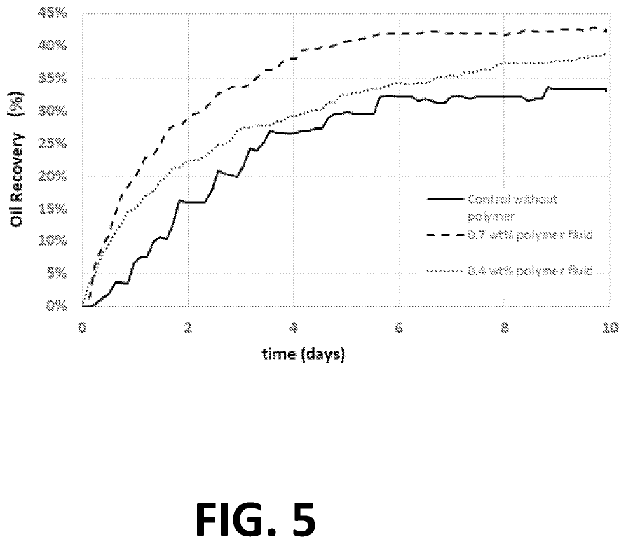

FIG. 5 depicts a demonstration of the oil displacement capacities of the disclosed polymer system. In FIG. 5, a fracturing fluid with different concentrations of polymers was treated with 0.5 ppt of ammonium persulfate at 80 degrees Celsius. It should be noted that other breakers can act in a similar fashion to break the polymer. In addition, hydrolysis can also lead to the release of the surfactant at appropriate pH and temperature. The oil displacement of the fracturing fluids is illustrated by a spontaneous imbibition test over a period of 10 days at the constant 80-degree Celsius temperature.

As shown in FIG. 5, fracturing fluids with 0.4 weight percent and 0.7 weight percent of polymer increase the amount of oil recovery over the duration of the experiment relative to the control without polymer. The control resulted in 33.1% oil recovery after 10 days, while the 0.4 wt % fluid resulted in approximately 38.5% oil recovery, and the 0.7 wt % fluid resulted in approximately 42.5% oil recovery. Additionally, the fracturing fluids with the polymer have a much higher oil recovery rate relative to the control without the polymer fluid. This is provided in FIG. 5 with greater oil recovery rates of the fracturing fluid with 0.7 and 0.4 wt % polymer relative to the control recovery rates, especially over the first four days.

Although the technology herein has been described with reference to embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

We claim:

1. A method of reducing friction in a fracturing fluid comprising:
mixing water and a polymer comprising at least one surfactant monomer, at least one hydrophilic monomer, and at least one glycol ether to form the fracturing fluid;
adding proppant to the fracturing fluid; and
pumping the fracturing fluid with reduced frictional energy losses into a wellbore for a fracturing operation.

2. The method of claim 1 wherein the at least one surfactant monomer comprises poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, poly(ethylene glycol) erucyl (meth)acrylate, poly(ethylene glycol) erucyl (meth)acrylamide, and combinations thereof.

3. The method of claim 1 wherein the surfactant monomer has a structure comprising one or more of: 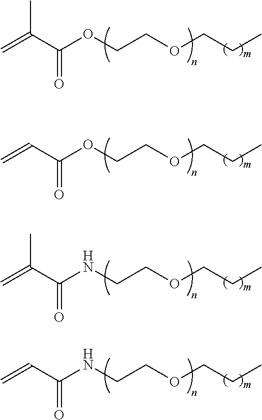
wherein m is between 1 and 30 and n is between 1 and 50.

4. The method of claim 1 wherein the at least one hydrophilic monomer comprises acrylate salts, acrylate, acrylamide, 2-acrylamido-2-methylpropane sulfonic acid salts, 2-acrylamido-2-methylpropane sulfonic acid, and combinations thereof.

5. The method of claim 1 wherein the at least one glycol ether comprises tripropylene glycol methyl ether, triethylene glycol methyl ether, diethylene glycol n-butyl ether, diethylene glycol monobutyl ether, dipropylene glycol n-butyl ether, propylene glycol phenyl ether, ethylene glycol hexyl ether, diethylene glycol hexyl ether, ethylene glycol phenyl ether, diethylene glycol ethyl ether, and combinations thereof.

6. The method of claim 1 further comprising:
reducing friction within the fracturing fluid by about 75% within one minute of adding the polymer.

7. The method of claim 6 further comprising:
maintaining friction reductions of greater than about 65% for at least 10 minutes after adding the polymer powder.

8. The method of claim 1 wherein the polymer is added to the fracturing fluid at a concentration of 0.025 wt % or 2.08 ppt.

9. The method of claim 1 further comprising:
prehydrating the polymer by combining water with a polymer powder prior to adding the polymer to form the fracturing fluid.

10. The method of claim 1 wherein the polymer and fracturing fluid is mixed for at least 30 seconds.

11. A method of enhancing oil recovery from a fracturing fluid comprising:
mixing water and a polymer comprising at least one surfactant monomer, at least one hydrophilic monomer, and at least one glycol ether to form the fracturing fluid;
adding proppant to the fracturing fluid;
pumping the fracturing fluid into a wellbore for a fracturing operation; and
increasing oil recovery from the wellbore after performing the fracturing operation.

12. The method of claim 11 wherein the at least one surfactant monomer comprises poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, poly(ethylene glycol) erucyl (meth)acrylate, poly(ethylene glycol) erucyl (meth)acrylamide, and combinations thereof.

13. The method of claim 11 wherein the surfactant monomer has a structure comprising one or more of: 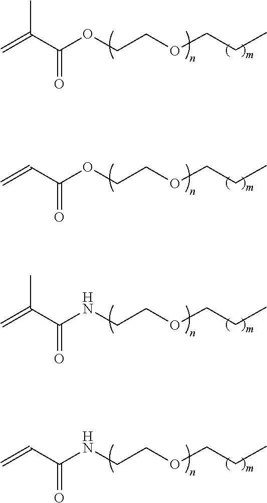
wherein m is between 1 and 30 and n is between 1 and 50.

14. The method of claim 11 wherein the at least one hydrophilic monomer comprises acrylate salts, acrylate, acrylamide, 2-acrylamido-2-methylpropane sulfonic acid salts, 2-acrylamido-2-methylpropane sulfonic acid, and combinations thereof.

15. The method of claim 11 wherein the at least one glycol ether comprises tripropylene glycol methyl ether, triethylene glycol methyl ether, diethylene glycol n-butyl ether, diethylene glycol monobutyl ether, dipropylene glycol n-butyl ether, propylene glycol phenyl ether, ethylene glycol hexyl ether, diethylene glycol hexyl ether, ethylene glycol phenyl ether, diethylene glycol ethyl ether, and combinations thereof.

16. The method of claim 11 further comprising:
increasing a relative oil recovery rate over a period of about 4 days.

17. The method of claim 11 further comprising:
increasing a total relative oil recovery over a period of about 10 days.

18. The method of claim 11 wherein the polymer is added to form the fracturing fluid at a concentration of about 0.4-0.7 wt %.

19. The method of claim 11 wherein the fracturing fluid further comprises about 0.5 ppt of ammonium persulfate.

20. The method of claim 19 wherein the ammonium persulfate breaks the fracturing fluid to increase oil recovery.
